(19) United States
(12) Patent Application Publication
(10) Pub. No.: US 2013/0234929 A1
(43) Pub. Date: Sep. 12, 2013

(54) ADAPTING MOBILE USER INTERFACE TO UNFAVORABLE USAGE CONDITIONS

(71) Applicant: EVERNOTE CORPORATION, Redwood City, CA (US)

(72) Inventor: Phil LIBIN, San Jose, CA (US)

(73) Assignee: Evernote Corporation, Redwood City, CA (US)

(21) Appl. No.: 13/727,189

(22) Filed: Dec. 26, 2012

Related U.S. Application Data
(60) Provisional application No. 61/607,820, filed on Mar. 7, 2012.

(51) Int. Cl. G06F 3/01

(52) U.S. Cl. CPC G06F 3/01
USPC 345/156

(57) ABSTRACT

Adapting a mobile user interface to unfavorable usage conditions includes detecting undesirable motion of the mobile device and providing adaptations to the mobile device user interface according to the undesirable motion, where the adaptations include at least one of: enlarging graphical elements of the mobile device, providing digital stabilization of images on the mobile device, providing additional warnings and user input options for critical operations, using modified gesture recognition algorithms, and adjusting system response to typing and drawing. The undesirable motion may be momentary or persistent. The adaptations that are provided may vary according to whether the undesirable motion is momentary or persistent. Undesirable motion that is momentary may be a bump, a dive and/or a sharp road turn. Undesirable motion that is persistent may include railroad vibration, plane vibration, and/or vessel pitching. The undesirable motion may be categorized by intensity as low, medium and high intensity.

### CROSS-REFERENCE TO RELATED APPLICATIONS

This application claims priority to U.S. Prov. App. No. 61/607,820, filed Mar. 7, 2012, and entitled “METHOD FOR OPTIMIZING USER INTERFACE ON MOBILE DEVICES TO ADAPT TO UNFAVORABLE USAGE CONDITIONS,” which is incorporated by reference herein.

### TECHNICAL FIELD

This application relates to the fields of human-machine interaction on mobile devices and presentation of visual and other information on such devices.

### BACKGROUND OF THE INVENTION

In 2012, about a hundred million people have been using, in their everyday lives, tablets with multi-touch screens, such as Apple iPad, Amazon Kindle Fire or Samsung Galaxy Tab. According to market forecasts, tablet usage will rapidly increase to almost one half of a billion units by 2015, with productivity applications, involving data editing, growing at an accelerated pace.

As truly mobile devices, tablets are utilized by many users on the road for work, reading and entertainment. Their lightness, powerful processors, high quality screens with sufficient size (typically, 7-11 inches but some vendors are exploring “oversized smartphones” with five-inch screens), seamless Internet connections in a variety of flavors, and thousands of useful applications make these devices a much desired everyday companion.

However, usage conditions for train, car, airplane and ship passengers, in certain industrial settings, and in other unfavorable situations may be substantially different from the conditions of a comfortable office or home environment. Devices are subject to rattling, bumping, diving, dipping, jitter and other interferences that may occur at random times. Device motion, unwanted and uncontrolled by the user, may affect user interactions with devices and applications, resulting in a series of undesired consequences. Examples include pressing wrong action buttons on touch-controlled devices and possible data loss during editing as a result of such misplaced clicks, mistypes on virtual keyboards, distorted hand drawings and handwritten text in pen-enabled of finger-controlled touch applications, misrecognized multi-touch gestures; etc. Depending on the frequency and amplitude of interferences to which the mobile device is exposed under unfavorable usage conditions, the screen may even look blurry or too unstable for viewing, which, in its turn, may prompt users to interrupt on-screen editing or even looking at displayed information on their devices for significant periods of time.

Accordingly, it is useful for mobile productivity applications and for implementing the satisfying mobile usage experiences to build a new generation of user interfaces (UIs) that improve productivity on the road and in other unfavorable usage conditions by reducing harmful consequences of uncontrolled movement of mobile devices.

### SUMMARY OF THE INVENTION

According to the system described herein, adapting a mobile user interface to unfavorable usage conditions includes detecting undesirable motion of the mobile device and providing adaptations to the mobile device user interface according to the undesirable motion, where the adaptations include at least one of: enlarging graphical elements of the mobile device, providing digital stabilization of images on the mobile device, providing additional warnings and user input options for critical operations, using modified gesture recognition algorithms, and adjusting system response to typing and drawing. The undesirable motion may be momentary or persistent. The adaptations that are provided may vary according to whether the undesirable motion is momentary or persistent. Undesirable motion that is momentary may be a bump, a dive and/or a sharp road turn. Undesirable motion that is persistent may include railroad vibration, plane vibration, and/or vessel pitching. The undesirable motion may be categorized by intensity as low, medium and high intensity. Adjusting system response to typing and drawing may vary according to the intensity of the undesirable motion. In response to the intensity of the undesired motion being high, typing and drawing inputs may be blocked. In response to the intensity of the undesired motion being medium, spell-checking and line smoothness verification may be performed following abatement of the undesired motion. User changes may be discarded in response to a number of errors detected by spell-checking and/or line smoothness verification. In response to the intensity of the undesired motion being low, the system may reject user touches that do not meet minimum criteria for duration and/or pressure level. In response to detection of undesirable motion, parameters for multi-touch gesture recognition may be adjusted to account for the undesirable motion. Undesired motion may be detected using spectral analysis of mobile device trajectories, g-force acceleration, orientation and/or rotation parameters based on input from at least one of: an accelerometer and a gyroscope. Adaptations may be provided only in response to the mobile device being placed in a travel mode. The mobile device may be placed in the travel mode manually by a user or semi-automatically by interaction of the mobile device with a network. Adapting a mobile user interface to unfavorable usage conditions may also include enhancing detection of interference using habitual routes travelled by the user of the mobile device. Enhancing detection may include analysis of interference along the habitual routes or may include having the user mark a map of the habitual routes to indicate areas of interference.

According further to the system described herein, computer software, provided in a non-transitory computer-readable medium, adapts a mobile user interface to unfavorable usage conditions. The software includes executable code that detects undesirable motion of the mobile device and executable code that provides adaptations to the mobile device user interface according to the undesirable motion, where the adaptations include at least one of: enlarging graphical elements of the mobile device, providing digital stabilization of images on the mobile device, providing additional warnings and user input options for critical operations, using modified gesture recognition algorithms, and adjusting system response to typing and drawing. The undesirable motion may be momentary or persistent. The adaptations that are provided may vary according to whether the undesirable motion is momentary or persistent. Undesirable motion that is momentary may be a bump, a dive and/or a sharp road turn. Undesirable motion that is persistent may include railroad vibration, plane vibration, and/or vessel pitching. The undesirable motion may be categorized by intensity as low, medium and high intensity. Adjusting system response to typing and drawing may vary according to the intensity of the undesirable motion. In response to the intensity of the undesired motion being high, typing and drawing inputs may be blocked. In response to the intensity of the undesired motion being medium, spell-checking and line smoothness verification may be performed following abatement of the undesired motion. User changes may be discarded in response to a number of errors detected by spell-checking and/or line smoothness verification. In response to the intensity of the undesired motion being low, the system may reject user touches that do not meet minimum criteria for duration and/or pressure level. In response to detection of undesirable motion, parameters for multi-touch gesture recognition may be adjusted to account for the undesirable motion. Undesired motion may be detected using spectral analysis of mobile device trajectories, g-force acceleration, orientation and/or rotation parameters based on input from at least one of: an accelerometer and a gyroscope. Adaptations may be provided only in response to the mobile device being placed in a travel mode. The mobile device may be placed in the travel mode manually by a user or semi-automatically by interaction of the mobile device with a network. The computer software may also include executable code that enhances detection of interference using habitual routes travelled by the user of the mobile device. Enhancing detection may include analysis of interference along the habitual routes or may include having the user mark a map of the habitual routes to indicate areas of interference.

Reducing harmful consequences of uncontrolled movement of mobile devices includes identification of motion of the mobile device and altering UI elements, application, and operating system behavior to facilitate user interaction with software applications and partially eliminate unwanted effects of uncontrolled motion after such effects have occurred. A goal of the system is increasing user productivity by allowing comfortable continued work on the road and under other unfavorable conditions where there may otherwise be an interruption of the device use waiting for the next period of smooth ride or other improvements in the usage condition; or, users may become irritated by repetitive “bumps”, “dives” and “dips” and stop using productivity applications on the go altogether.

Techniques for identifying unwanted motion are known and include spectral analysis of device trajectories in Cartesian and/or angular coordinate systems based on accelerometer and/or gyroscope motion detection. This applies to shaking, vibrations, jitter, jolt (changes in acceleration), bump, dive or dip detection calculations, etc. Detected interferences may be categorized by duration as singular (momentary or short-term, such as a bump, a dive, a dip or a sharp road turn) and persisting (such as a railroad or plane vibration or a vessel pitching); other types of duration may also be included in the categorization. The interferences may be categorized by intensity as low, medium and high intensity movements; more detailed intensity gradation scales are also possible.

In an embodiment of the system described herein, such detection techniques and the respective dynamic changes to the UI are applied in a dedicated travel mode of the mobile device (similar to the travel/flight mode on mobile phones). Travel mode may be enabled manually by a user or semi-automatically by interaction of the user device with wireless or other networks present on board of a vehicle or a vessel. Restricting permanent motion tracking and advanced UI behavior to the travel mode may preserve battery life and guard against unreasonable reactions to different types of user controlled device motion, for example a user walking around the office or home with a tablet or a user playing a video game that requires motion of the device.

In another embodiment of the system described herein, the detection of unwanted device movements may be enhanced by customizing the detection to habitual routes, such as everyday trips between home and office in a train or in a car (for example, by a carpool passenger). In this case, device movement along repetitive routes may be first recorded and then analyzed for typical interferences, e.g. when a train takes its sharpest turns along the route or accelerates/decelerates near stops along the route. A route obstacle map or a route profile may be built by the system and presented to the user, allowing the user mark up, subsequent recognition of the highlighted interferences during subsequent trips, and advising the mobile device on changing UI elements or behavior in response to specific unwanted conditions along the route.

Once an unfavorable motion of the mobile device has been detected, the system may change UI appearance and behavior, depending on the character, intensity and duration of the motion, and on the user activity accompanying or following the interference. In different embodiments, such changes may include one or more of any or all of the actions described below.

When a user performs critical operations, such as saving or deleting content, in an application on the mobile device subjected to permanent interferences, the system may display additional warning messages that may be unneeded under favorable usage conditions. Such messages may require additional confirmations by the user of an intended operation.

When the persisting interferences are detected, the system may display enlarged application icons, buttons, menu headings and other interactive UI elements, in order to facilitate for the user pressing, clicking and other operations using finger or pen touch, joystick, touchpad or other available input interface.

When the persisting interferences affecting a mobile device include vibration, shaking or jitter, the interferences may impair a user's ability to clearly see the content of the device screen, since both the viewing distance and the angle may be rapidly changing. Depending on the frequency spectrum and the amplitudes of interferences, the screen may blur, jump or exhibit other undesirable effects. In such a case, the system may invoke a real-time digital stabilization of the screen image by occupying a few pixel-wide outer frame of the screen as a pixel buffer, recalculating screen appearance in real time according to the sensor data and refreshing the screen so that the screen appears to the user as a still image.

Whenever the persisting unwanted movements of a mobile device with a multi-touch screen are detected, changes may be made to the parameters of the gesture recognition, normally performed by the system software and/or software drivers. For example, when a two-finger tap gesture is made by a user and the device is vibrating or shaking, the screen may jump toward the tapping fingers right after the fingers leave the screen after tapping and may touch the fingers again, causing an effect of an undesirable second two-finger tap. Under normal conditions, such tap would be interpreted by the gesture recognition system software as a two-finger double tap, which the user did not intend and which, in many cases, would perform different functions than in response to a single two-finger tap, thus potentially causing an error. In order to avoid such issues, the system may narrow the parameter zone for the acceptance of each of the tap and double tap gestures, requiring a more distinct and reliable interaction between a finger and the touch screen to occur, in order to categorize the gesture as a single or double tap. Correspondingly, the rejection zone may be broadened, i.e. the parameter area where the system does not make a gesture choice and does not perform an action, waiting for the repetitive and the more precise gesture, may be expanded. Similar actions may apply to any pair of similar gestures that may be confused by the system when the unwanted movements of the device occur; examples include one-finger tap vs. one-finger double tap, pinching vs. rotating with two fingers, etc.

Just as with changing response to input gestures under the unfavorable usage conditions, the system may tighten text input requirements for the on-screen touch keyboard. Since the shaking, vibrating or jolting device may cause finger slippage and occasional touches of the wrong keys, the input mode under persisting interferences may require more reliable touches of the keys, with higher pressure levels and longer touch intervals, in order to consider the input valid. Additionally, the system may use other means to improve text entry accuracy under unfavorable usage conditions. In one embodiment, the system records portions of the text input entered under the shaking, jolting or other undesirable movement conditions and automatically applies spell-checking to such portions of text; if the number of errors significantly exceeds the regular error rate for the user, the portion is automatically dropped (undone) and requires special user instructions to redo the portion. In another embodiment, the system additionally blocks the keyboard input altogether every time the strength of interferences exceeds certain levels; thus, the system would block the text input of a non-driver car passenger every time the car bumps or dips, meets a rough surface or makes a sharp turn.

In an embodiment of the system described herein, controls similar to those offered for text entry are provided for other types of input. Portions of the input may be recorded into a temporary buffer, checked it for consistency, and added to the main input stream if the input satisfies consistency criteria. In one embodiment, the system may check line smoothness for freehand drawings and handwritten text entry and may undo the lines that have excessive jitter or fast shooting segments indicating a slippage of the pen or the drawing finger.

### BRIEF DESCRIPTION OF THE DRAWINGS

Embodiments of the system described herein will now be explained in more detail in accordance with the figures of the drawings, which are briefly described as follows.

FIGS. 1A and 1B are schematic illustrations of an automatic enlargement of application icons and buttons under unfavorable usage conditions according to embodiments of the system described herein.

FIG. 2 illustrates displaying an additional warning for critical operations performed under unfavorable usage conditions according to embodiments of the system described herein.

FIG. 3 is a schematic illustration of digital stabilization of a screen subjected to jitter or other unfavorable usage conditions causing screen blur or other effects preventing a user from clearly seeing screen content according to embodiments of the system described herein.

FIGS. 4A-4B illustrate a difference between gesture recognition modes under a non-obstructed condition and a persisting interferences according to embodiments of the system described herein.

FIGS. 5A-5D are system flow diagrams that describe processing associated with different embodiments of the system described herein.

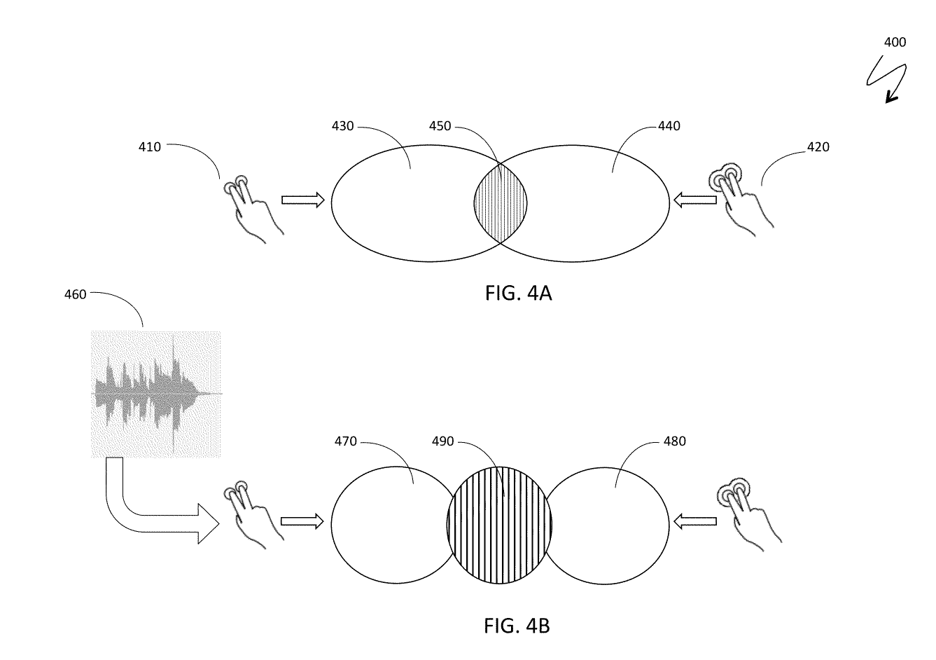

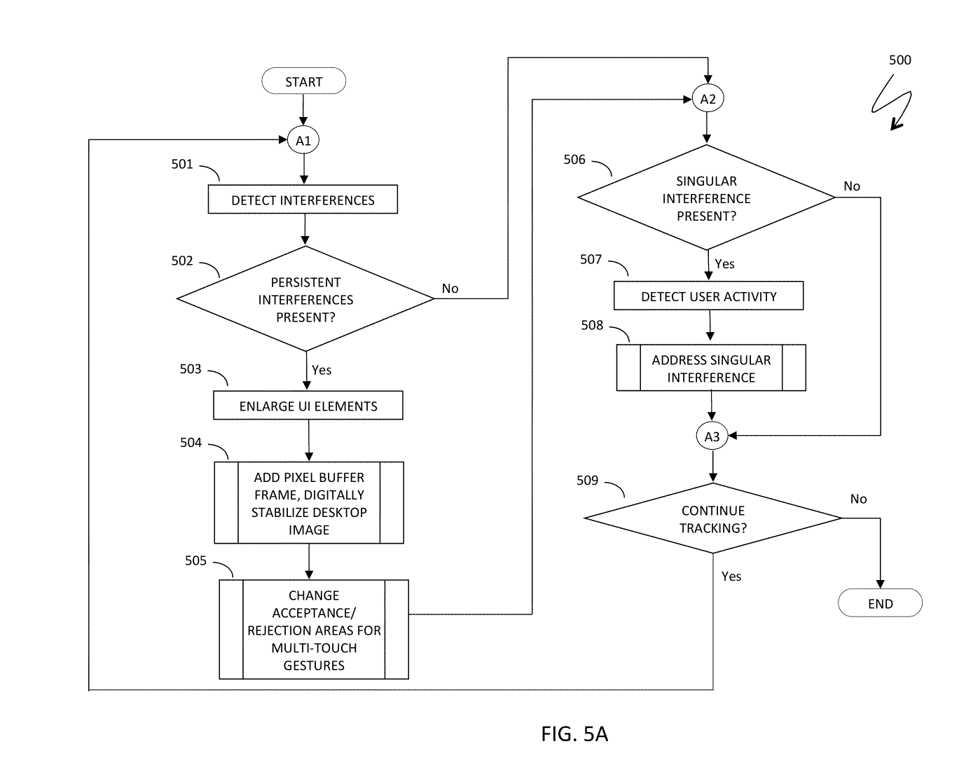

Gesture icons on FIGS. 4A-4B have been designed by Gestureworks, http://gestureworks.com.

### DETAILED DESCRIPTION OF VARIOUS EMBODIMENTS

The system described herein provides various techniques for adapting user interface and usage experiences on mobile devices to unfavorable usage conditions, generally categorized as persisting or singular interferences, such as shaking, jittering, jolting, vibrating, bumping, dipping, diving and other unwanted movements of the device detected by the device sensors, for example, accelerometers and gyroscopes. Once the input signal from sensors is analyzed and the type and intensity of the interference is detected, the system may modify different aspects of the UI and some of the interaction parameters and behavior, and present a user with the updates helping to minimize the unwanted effects.

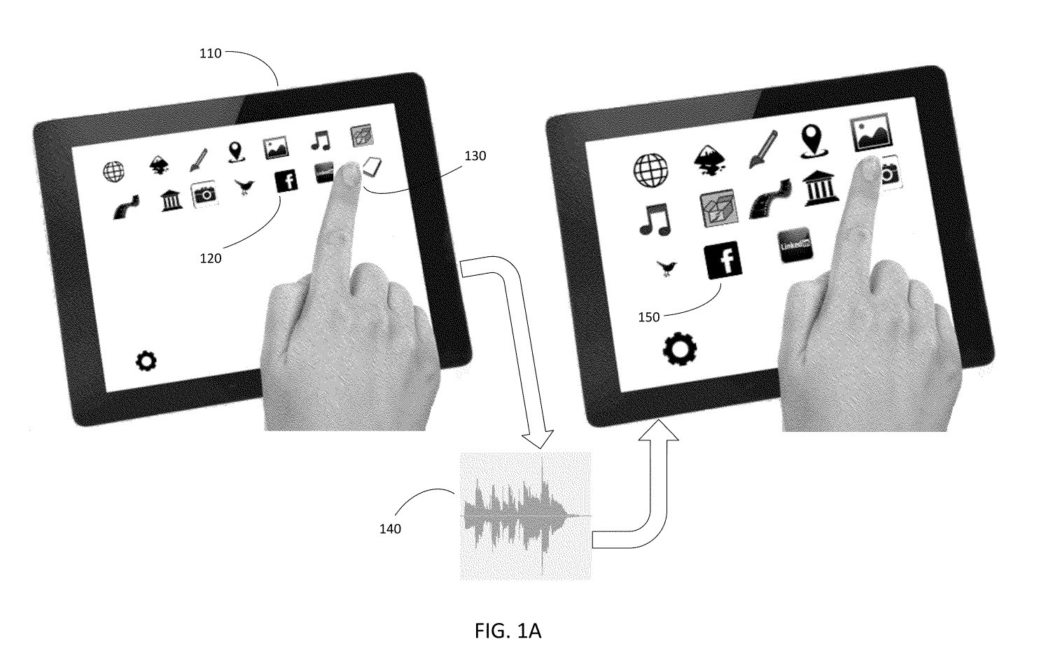

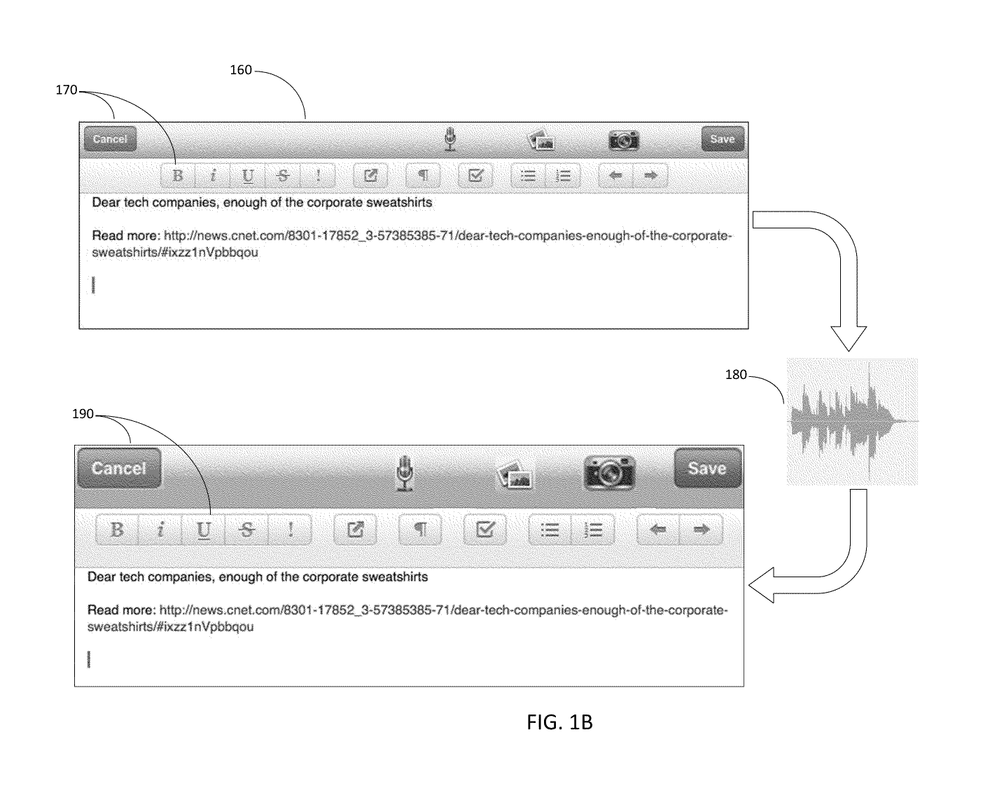

FIGS. 1A-1B provide a a schematic illustration of various types of enlarged application icons on the device desktop and of enlarged action buttons in a device software in response to detected persistent interferences associated with the unfavorable usage conditions. FIG. 1A illustrates an embodiment where the size of on-screen icons may be altered depending on the intensity of unfavorable user conditions. Under the normal (relatively stationary), unobstructed conditions, the device screen 110 displays application icons 120 in their regular size; a user can conveniently tap the on-screen icons with a finger 130. Once interference 140 is detected, analyzed and categorized as persistent interference, it may become significantly more difficult for the user to tap on-screen icons. Accordingly, the system displays larger icon images 150, as explained elsewhere herein, and makes it easier for the user to invoke the installed applications by tapping the icon images 150 with a finger or targeting the icon images 150 using other input interface. In some embodiments, linear icon size may be doubled (square size quadrupled) to facilitate application launch. Of course, other size increases are possible.

FIG. 1B illustrates an embodiment where application action buttons may be enlarged in response to persistent interferences. An application window 160 includes application icons 170 in a normal display size. Once interference 180 is detected and categorized as persistent interference, the application buttons 190 may be redrawn in a larger size to facilitate finger operation on a touch screen, as well as targeting the buttons 190 using other input interface. The enlargement coefficient depends on the intensity of interference, toolbar design, availability of free space in the toolbar, importance of the associated operations, etc. In the example shown in FIG. 1B, the linear size of action buttons responsible for the critical operations of saving or canceling a note has been increased under unfavorable condition by 50%, while the size of formatting buttons in the editing toolbar (i.e., non-critical operations) has been increased by 40%. Of course, other size increases are possible.

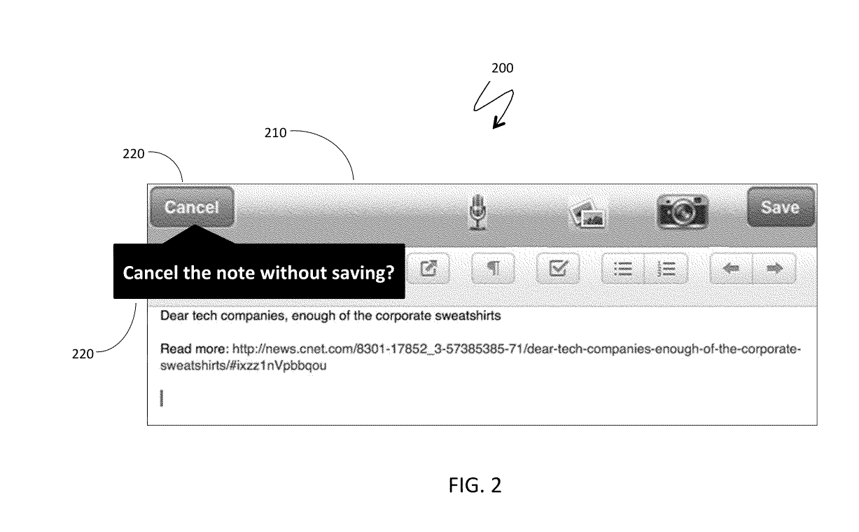

FIG. 2 is a schematic illustration 200 of an embodiment of the system whereby, in addition to enlarging the application buttons, additional warnings may be displayed when critical operations in the application are performed and a singular interference is detected. An application window 210 has a Cancel button 220 which a user presses to cancel content capturing in a note. Under the unfavorable usage conditions with a strong singular interference, such as a bump, dip or dive, a tap may be accidental, caused by an undesired device movement when the user's finger was relatively close to the screen surface. Because canceling of the content capturing process may result in a data loss, the system launches a warning 220 requiring the user to confirm the intent. In the embodiment illustrated in FIG. 2, the user may be invited to confirm the operation by re-tapping the Cancel button 220. If the button 220 remains untapped for a certain short period of time, the warning message disappears from the screen and the first tap is considered an error.

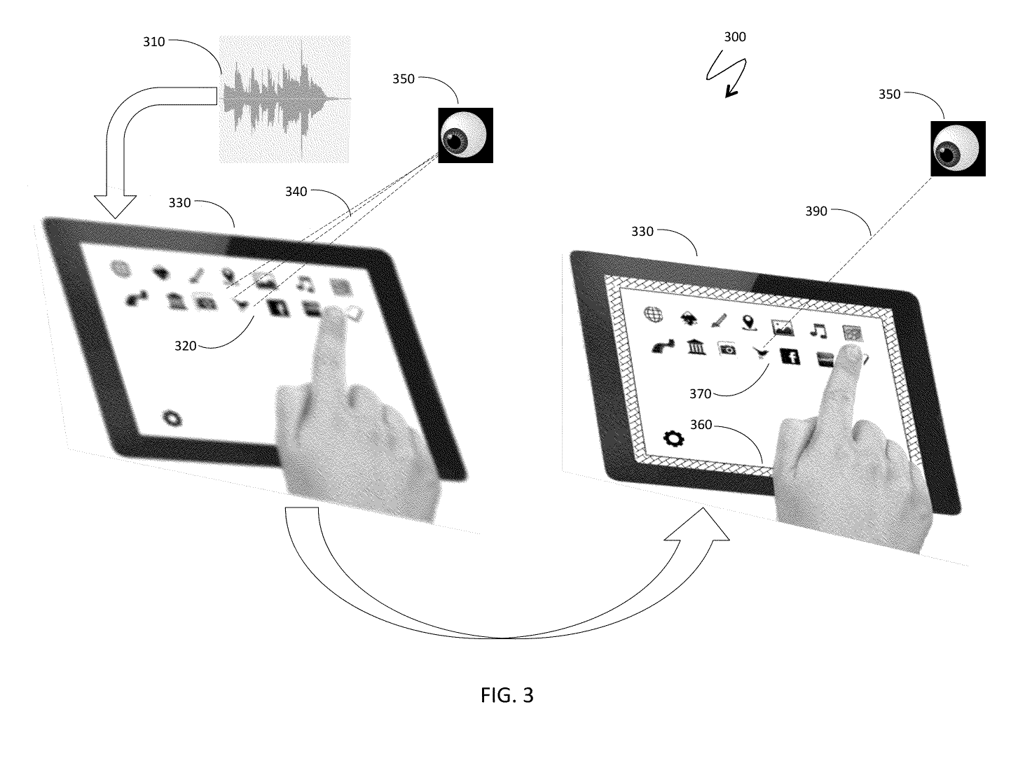

FIG. 3 is a schematic illustration 300 of an embodiment of the system whereby a digital stabilization of the screen image is provided. When unfavorable usage conditions 310 affect the device, a desktop or application image 320 drawn by the system or application software may appear blurry or jittery, because a distance and viewing angle 340 between a screen 330 and an eye 350 of a user is rapidly changing. In order to eliminate visual defects, a traditional digital stabilization may be used: an outer pixel buffer frame 360 is added to the screen image, and the screen 330 is refreshed in real time according to the measurements of motion and angle sensors by the system, so that the shift and angle changes are absorbed by the buffer frame and a redrawn image 370 within the frame appears stable, i.e. creates an impression that the eye 350 views the screen 330 at a permanent angle and distance 390. In the event of intentional moves and turns of the device by the user, the angle and distance may, of course, change together with the screen view; the angle and distance are not compensated by the system and the pixel buffer frame, since the system distinguishes between the persistent interferences and a singular move, based on the sensor measurements and analysis thereof.

FIGS. 4A-4B are combined into a comparative schematic illustration 400 of showing a difference in multi-touch gesture recognition under the normal (relatively stationary) conditions vs. unfavorable usage conditions. In FIG. 4A, a gesture recognition chart is exemplified by distinguishing between two multi-touch gestures: a two-finger single tap 410 and a two-finger double tap 420. Under normal (relatively stationary) usage conditions, after parameters are extracted from an input stream of touch events, acceptance areas for a first gesture alternative 430 and a second gesture alternative 440 in time-coordinate-feature space are overlapping by a relatively narrow area 450. The area 450 represents an uncertainty area, i.e. a rejection zone where the system does not choose a winner and drops the gesture (does nothing in response to the input).

FIG. 4B illustrates system processing of a two-finger single tap and a two-finger double tap under unfavorable usage conditions 460. The acceptance areas 470, 480 in the time-coordinate-feature space are shrunk by the system, and an uncertainty parameter area for rejection 490 is larger than the area 450 used for normal conditions. The larger area 490 accounts for situations where unwanted device motion interferes with correct interpretation of a gesture, as explained elsewhere herein.

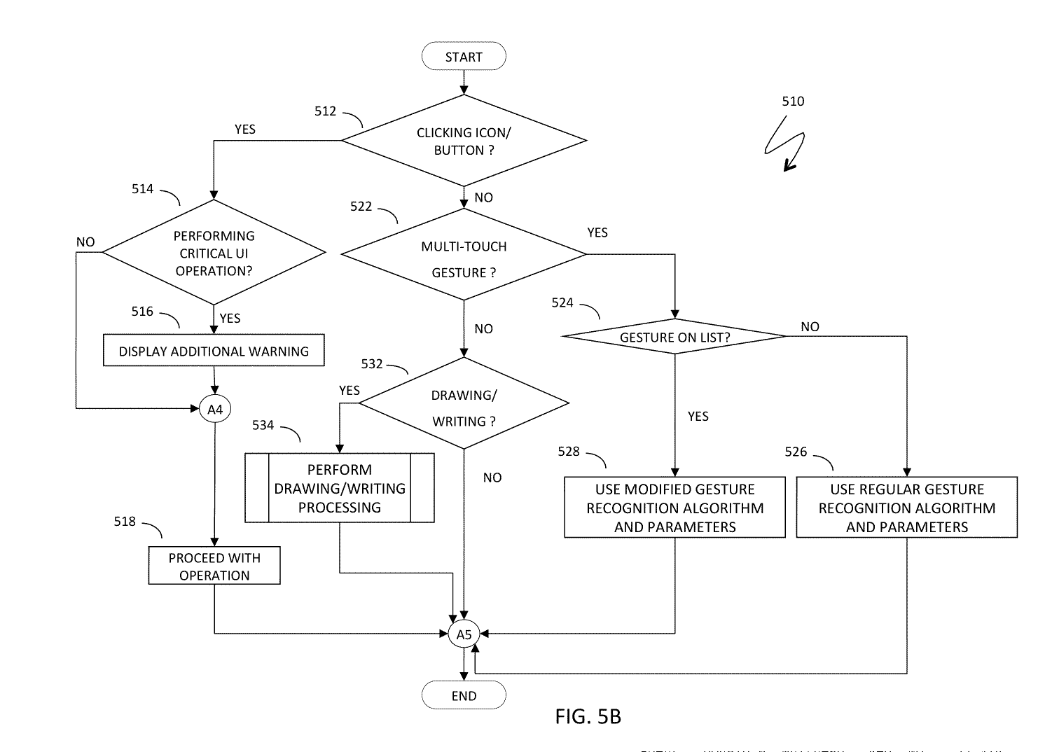

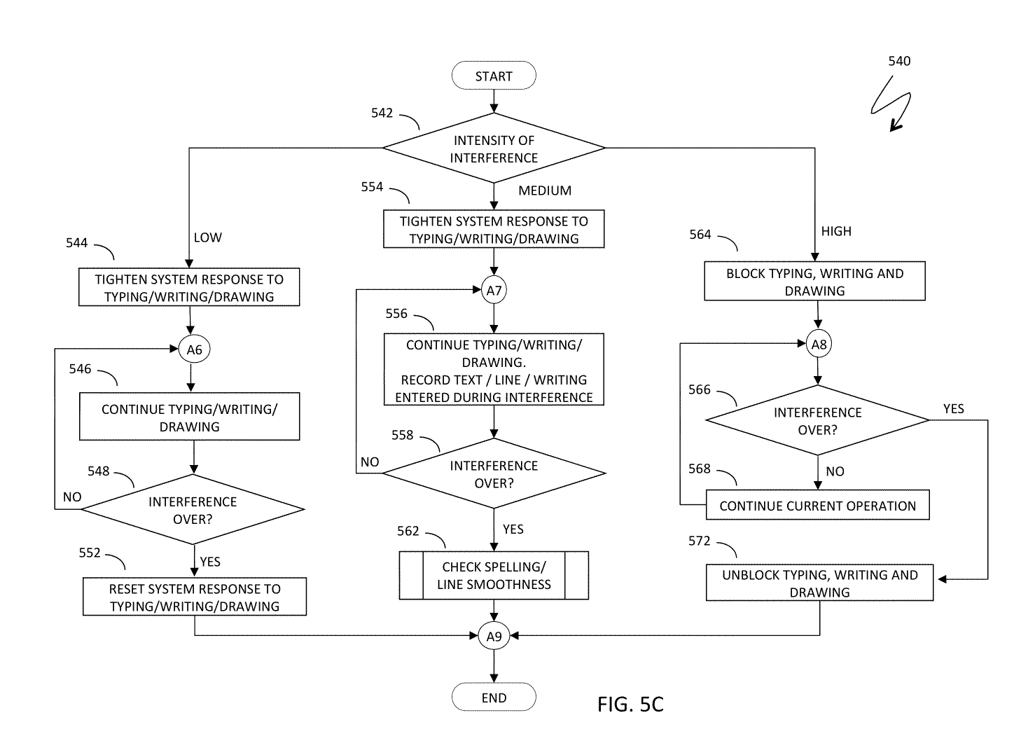

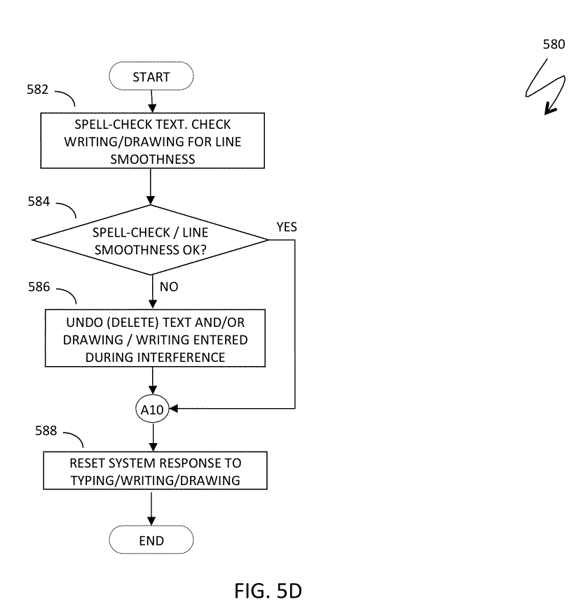

Referring to FIG. 5A, a flow diagram 500 illustrates processing performed in connection with detecting interferences and user activities and customizing the UI to diminish the effect of the unfavorable usage conditions. Processing starts at a step 501 where the system receives data from sensors of the device to detect interference. After the step 501, processing proceeds to a test step 502, where it is determined whether persistent interferences are present. If not, then processing proceeds to a test step 506. Otherwise, processing proceeds to a step 503 where UI elements are enlarged in response to the confirmed persistent interferences and in accordance with user actions on the device desktop or within running software applications on the device, as explained elsewhere herein. After the step 503, processing proceeds to a step 504, where a pixel buffer frame is added to the screen and the desktop image is digitally stabilized, as explained elsewhere herein. After the step 504, processing proceeds to a step 505, where the acceptance and rejection areas in the time-coordinate-feature space for distinguishing between different pairs of similar multi-touch gestures are changed by the system.

After the step 505, processing proceeds to the test step 506, where it is determined whether a singular interference, such as a car bump or dip, a plane dive due to turbulence, or a sharp turn by a train, is detected. Note that the test step 506 is also reached from the test step 502, described above, if no persistent interferences are present. If a singular interference is present, processing proceeds to a step 507 where the current user activity is detected. After the step 507, processing proceeds to a step 508, where the detected singular interference is addressed depending on the detected user activity. Processing performed at the step 508 is discussed in more detail elsewhere herein. After the step 508, processing proceeds to a test step 509, where it is determined whether tracking of unfavorable user conditions and user activities has to be continued. Note that the test step 509 is also reached from the step 506, described above, if no singular interference is detected. If tracking is to continue, control returns to the starting step 501, described above. If tracking is not to continue (for example, the user has exited the travel mode on the mobile device), then processing is complete.

Referring to FIG. 5B, a flow diagram 510 provides a more detailed description of addressing a singular interference at the step 508 dependent upon user activity. User activity includes clicking an application icon or button, a multi-touch gesture, or drawing/writing on the touch screen in an application supporting handwritten input. Processing starts at a test step 512 it is determined if the user is clicking an application icon or button. If so, then processing proceeds to a test step 514 where it is determined if the user is performing a critical UI operation (e.g. by comparing the current operation to a pre-determined list of such critical operations). If so, then processing proceeds to a step 516 where the system displays an additional warning, so that, if the button or icon click was an unwanted action due to device shaking, bump, dip, dive or other interference, the user has a chance to cancel or ignore the unnecessary operation, as explained elsewhere herein (see also FIG. 2). If it is determined at the test step 514 that the user is not performing a critical operation, then processing proceeds to a step 518 to continue with the user operation. Note that the step 518 also follows the step 516. Following the step 518, processing is complete.

If it is determined at the test step 512 that the user is not clicking on an icon or button, then control transfers from the test step 512 to a test step 522 where it is determined if the user is making a multi-touch gesture. If so, then processing proceeds to a test step 524 where it is determined whether the gesture (as identified so far by a preliminary identification of the gesture by the system software) is on a pre-determined list of gestures that may be error-prone (i.e., may be misrecognized by the system due to unwanted movements of the device under the unfavorable usage conditions). If not, then control is transferred to a step 526 where the system uses regular (normal condition) gesture recognition algorithm and parameters. If the gesture is on the list of error-prone gestures, then processing proceeds to a step 528 where modified gesture recognition algorithm and parameters are used for more demanding requirements to the gesture to be reliably recognized, as explained elsewhere herein (see also FIG. 4B). Following either of the steps 526, 528, processing is complete.

If it is determined at the test step 522 that the user is not performing a multi-touch gesture, then control transfers from the test step 522 to a test step 532 where it is determined if the user is drawing or writing. If not, then processing is complete. Otherwise, control transfers from the test step 532 to a step 534 where the system performs drawing/writing processing, as described in more detail elsewhere herein. Following the step 534, processing is complete.

Referring to FIG. 5C, a flow diagram 540 provides a more detailed description of processing performed at the step 534, described above, relating to handling typing on an on-screen touch keyboard or drawing/handwriting in an appropriate application running on the device. Processing begins at a test step 542 where an intensity of the interference is measured and categorized as either low, medium or high. In case of the low-intensity interference, such as a bump or dip with the peak acceleration 0.05 g to 0.1 g in a moving car, processing proceeds to a step 544 where the system response to typing, writing or drawing is tightened, by, for example, the system ignoring key touches that don't meet refined minimal pressure and/or contact time requirements. After the step 544, processing proceeds to a step 546, where the user continues typing, writing or drawing under the tightened system response.

Following the step 546, processing proceeds to a test step 548, where it is determined whether the interference condition/state is over. This may be achieved, for example, by sending inquiries to or receiving a signal from an interference tracking system like used in connection with the step 501 of FIG. 5A. If the interferences persist, processing proceeds back to the step 523 where typing, writing or drawing under the tightened system response is continued. If the interference state/condition is over, then processing proceeds to a step 552 where the system is reset to provide the normal response to typing, writing or drawing. Following the step 552, processing is complete.

In case of the medium-intensity interference, for example, with the peak acceleration of 0.1 g to 0.2 g in a moving car, processing proceeds from the test step 542 to a step 554, which is similar to the step 544 and tightens the system response to typing, writing or drawing, requiring additional pressure and, generally speaking, slower processing for the touches to be successfully validated in that mode. After the step 554, processing proceeds to a step 556, where the user continues typing, writing or drawing under the tightened system response, and the system records a fragment of typed text, handwriting or drawing for the subsequent verification. After the step 556, processing proceeds to a test step 558, where it is determined whether the interference condition/state is over. If not, then processing proceeds back to the step 556, where the user continues with the current activity under tightened conditions. If the interference is over, processing proceeds to a step 562 where the verification of the recorded data is performed and the corresponding action is performed. Verification may include, in different embodiments, spell-checking of the typed text and comparing the error rate with the average such rate for the user; analyzing hand-drawn line for smoothness, absence of jitter or “shooting lines” (indicators of slippage of the writing instrument), etc. Processing performed at the step 562 is discussed in more detail elsewhere herein. Following the step 562, processing is complete.

In case of the strong, high-intensity interference detected at the step 542, for example bumps or dips with the acceleration above 0.2 g in a moving car, processing proceeds to a step 564 where the system completely (and temporarily) blocks typing on any on-screen touch keyboard, as well as writing and/or drawing in all or some applications running on the device. After the step 564, processing proceeds to a test step 566, where it is verified whether the interference is over. If not, then processing proceeds to a step 568, where the user continues current operations (that do not include the blocked activities). Following the step 568, processing proceeds back to the step 566 to determine if the interference condition/state has ended. If it is determined at the test step 536 that the interference is over, then processing proceeds to a step 572 where all previously blocked activities, such as typing, writing and drawing, are unblocked. Following the step 572, processing is complete.

Referring to FIG. 5D, a flow diagram 580 illustrates in more detail processing performed at the step 562, described above, where the verification of the recorded data is performed. The flow diagram 580 pertains to a post-interference situation as explained in connection with FIG. 5C. Processing begins at a step 582 where a spell-check (in the case of typing) or smoothness checking (in the case of drawing) is performed. Following the step 582 is a step 584 where a decision is made whether typing, drawing or writing of a user is within acceptable parameters or has been affected by unwanted device movements (i.e. the typed text has excessive spell-check error rate or the handwriting/hand-drawn lines show strong jitter or signs of slippage of the writing instrument). If data is acceptable, then processing proceeds to a step 588 where the system response is reset to the standard values. If the data is noticeably affected by the interference, processing proceeds to a step 586 where the system deletes (undoes) the affected segment of text, handwriting or drawings. After the step 586, processing proceeds to the step 588, described above. Following the step 588, processing is complete.

Various embodiments discussed herein may be combined with each other in appropriate combinations in connection with the system described herein. Additionally, in some instances, the order of steps in the flowcharts, flow diagrams and/or described flow processing may be modified, where appropriate. Subsequently, elements and areas of screen described in screen layouts may vary from the illustrations presented herein. Further, various aspects of the system described herein may be implemented using software, hardware, a combination of software and hardware and/or other computer-implemented modules or devices having the described features and performing the described functions. The mobile device may be a tablet or a cell phone, although other devices are also possible. Note that the system described herein may work with a desktop, a laptop, and/or any other computing device in addition to a mobile device.

Software implementations of the system described herein may include executable code that is stored in a computer readable medium and executed by one or more processors. The computer readable medium may be non-transitory and include a computer hard drive, ROM, RAM, flash memory, portable computer storage media such as a CD-ROM, a DVD-ROM, a flash drive, an SD card and/or other drive with, for example, a universal serial bus (USB) interface, and/or any other appropriate tangible or non-transitory computer readable medium or computer memory on which executable code may be stored and executed by a processor. The system described herein may be used in connection with any appropriate operating system.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method of adapting a mobile user interface to unfavorable usage conditions, comprising:
detecting undesirable motion of the mobile device; and
providing adaptations to the mobile device user interface according to the undesirable motion, wherein the adaptations include at least one of: enlarging graphical elements of the mobile device, providing digital stabilization of images on the mobile device, providing additional warnings and user input options for critical operations, using modified gesture recognition algorithms, and adjusting system response to typing and drawing.

2. A method, according to claim 1, wherein the undesirable motion is one of: momentary and persistent.

3. A method, according to claim 2, wherein the adaptations that are provided vary according to whether the undesirable motion is momentary or persistent.

4. A method, according to claim 2, wherein undesirable motion that is momentary includes at least one of: a bump, a dive and a sharp road turn.

5. A method, according to claim 2, wherein undesirable motion that is persistent includes at least one of: railroad vibration, plane vibration, and vessel pitching.

6. A method, according to claim 1, wherein the undesirable motion is categorized by intensity as low, medium and high intensity.

7. A method, according to claim 6, wherein adjusting system response to typing and drawing varies according to the intensity of the undesirable motion.

8. A method, according to claim 7, wherein, in response to the intensity of the undesired motion being high, typing and drawing inputs are blocked.

9. A method, according to claim 7, wherein, in response to the intensity of the undesired motion being medium, spell-checking and line smoothness verification are performed following abatement of the undesired motion.

10. A method, according to claim 9, wherein user changes are discarded in response to a number of errors detected by at least one of: spell-checking and line smoothness verification.

11. A method, according to claim 7, wherein, in response to the intensity of the undesired motion being low, the system rejects user touches that do not meet a minimum criteria for at least one of:
duration and pressure level.

12. A method, according to claim 1, wherein in response to detection of undesirable motion, parameters for multi-touch gesture recognition are adjusted to account for the undesirable motion.

13. A method, according to claim 1, wherein undesired motion is detected using spectral analysis of mobile device trajectories, g-force acceleration, orientation and rotation parameters based on input from at least one of: an accelerometer and a gyroscope.

14. A method, according to claim 1, wherein adaptations are provided only in response to the mobile device being placed in a travel mode.

15. A method, according to claim 14, wherein the mobile device is placed in the travel mode manually by a user.

16. A method, according to claim 14, wherein the mobile device is placed in the travel mode semi-automatically by interaction of the mobile device with a network.

17. A method, according to claim 1, further comprising:
enhancing detection of interference using habitual routes travelled by the user of the mobile device.

18. A method, according to claim 17, wherein enhancing detection includes analysis of interference along the habitual routes.

19. A method, according to claim 17, wherein enhancing detection includes having the user mark a map of the habitual routes to indicate areas of interference.

20. Computer software, provided in a non-transitory computer-readable medium, that adapts a mobile user interface to unfavorable usage conditions, the software comprising:
executable code that detects undesirable motion of the mobile device; and
executable code that provides adaptations to the mobile device user interface according to the undesirable motion, wherein the adaptations include at least one of: enlarging graphical elements of the mobile device, providing digital stabilization of images on the mobile device, providing additional warnings and user input options for critical operations, using modified gesture recognition algorithms, and adjusting system response to typing and drawing.

21. Computer software, according to claim 20, wherein the undesirable motion is one of:
momentary and persistent.

22. Computer software, according to claim 21, wherein the adaptations that are provided vary according to whether the undesirable motion is momentary or persistent.

23. Computer software, according to claim 21, wherein undesirable motion that is momentary includes at least one of: a bump, a dive and a sharp road turn.

24. Computer software, according to claim 21, wherein undesirable motion that is persistent includes at least one of: railroad vibration, plane vibration, and vessel pitching.

25. Computer software, according to claim 20, wherein the undesirable motion is categorized by intensity as low, medium and high intensity.

26. Computer software, according to claim 25, wherein adjusting system response to typing and drawing varies according to the intensity of the undesirable motion.

27. Computer software, according to claim 26, wherein, in response to the intensity of the undesired motion being high, typing and drawing inputs are blocked.

28. Computer software, according to claim 26, wherein, in response to the intensity of the undesired motion being medium, spell-checking and line smoothness verification are performed following abatement of the undesired motion.

29. Computer software, according to claim 28, wherein user changes are discarded in response to a number of errors detected by at least one of: spell-checking and line smoothness verification.

30. Computer software, according to claim 26, wherein, in response to the intensity of the undesired motion being low, the system rejects user touches that do not meet a minimum criteria for at least one of: duration and pressure level.

31. Computer software, according to claim 20, wherein in response to detection of undesirable motion, parameters for multi-touch gesture recognition are adjusted to account for the undesirable motion.

32. Computer software, according to claim 20, wherein undesired motion is detected using spectral analysis of mobile device trajectories, g-force acceleration, orientation and rotation parameters based on input from at least one of: an accelerometer and a gyroscope.

33. Computer software, according to claim 20, wherein adaptations are provided only in response to the mobile device being placed in a travel mode.

34. Computer software, according to claim 20, wherein the mobile device is placed in the travel mode manually by a user.

35. Computer software, according to claim 20, wherein the mobile device is placed in the travel mode semi-automatically by interaction of the mobile device with a network.

36. Computer software, according to claim 20, further comprising:
executable code that enhances detection of interference using habitual routes travelled by the user of the mobile device.

37. Computer software, according to claim 36, wherein enhancing detection includes analysis of interference along the habitual routes.

38. Computer software, according to claim 36, wherein enhancing detection includes having the user mark a map of the habitual routes to indicate areas of interference.
